(19) United States
(12) Patent Application Publication
(10) Pub. No.: US 2019/0380310 A1
(43) Pub. Date: Dec. 19, 2019

(54) PET HARNESS SYSTEM

(71) Applicant: Bradley Daniel Schneider, Vancouver (CA)

(72) Inventor: Bradley Daniel Schneider, Vancouver (CA)

(21) Appl. No.: 16/012,720

(22) Filed: Jun. 19, 2018

(51) Int. Cl. A01K 27/00; A01K 13/00; A01K 7/00

(52) U.S. Cl. CPC A01K 27/002; A01K 13/006; A01K 27/005; A01K 7/005; A01K 27/008; A01K 27/006; A01K 27/003

(57) ABSTRACT

A pet harness system including a harness assembly including a wrap harness having, a pair of leg apertures, a closure-section, a first-ring, and a second-ring, a split leash having a first-end and a second-end. The wrap harness is configured to be worn by a pet. The closure-section includes a fastener which is configured to secure the wrap harness around a pet-body. The first-ring is configured to receive the first-end of the split leash and the second-ring is configured to receive the second-end of the split leash. The split leash and the wrap harness may be used in combination for controlling an animal.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field Of The Invention

The present invention relates generally to the field of pet accessories and more specifically relates to a canine harness.

### 2. Description Of Related Art

A dog harness is piece of equipment for dogs, generally similar to harness tack for horses. There are various designs depending on the type of use, whether it be for assistance to a person with a disability, hauling a cart or sled, or pulling a human being, such as in skijoring or pulka. Harnesses are also commonly worn by non-working dogs. A harness is commonly worn in conjunction with a collar and used as an alternative for leash attachment. While a collar only encircles the neck, H-style harnesses have a loop that surrounds the torso as well, with connecting straps between them for reinforcement. This design allows for distribution of force which may prevent choking and a lower chance of slipping out than may be possible with only a collar.

U.S. Pat. No. 7,918,192 to Mary Riley Digh relates to a multi-purpose pet utility vest. The described multi-purpose pet utility vest for a pet incorporates a body portion, and a pocket assembly carried by the body portion. The pocket assembly includes overlying outside and inside pocket layers. The outside and inside pocket layers are formed together along a dividing line to define first and second isolated utility compartments having respective first and second access openings for receiving and storing articles therein. A bag-dispensing grommet is attached to the outside pocket layer, and defines a small hole communicating with the first utility compartment for dispensing disposable plastic bags stored in the first utility compartment.

### BRIEF SUMMARY OF THE INVENTION

In view of the foregoing disadvantages inherent in the known pet accessories art, the present disclosure provides a novel pet harness system. The general purpose of the present disclosure, which will be described subsequently in greater detail, is to provide a split leash and the wrap harness configured to be used in combination for controlling an animal.

A pet harness system is disclosed herein. The pet harness system includes a harness assembly including a wrap harness having, a pair of leg apertures, a closure-section, a first-ring, and a second-ring, and a split leash having a first-end and a second-end. The wrap harness is configured to be worn by a pet. The pair of leg apertures are each configured to receive a leg of the pet. The closure-section includes a fastener which is configured to secure the wrap harness around a pet-body. The first-ring is configured to receive the first-end of the split leash and the second-ring is configured to receive the second-end of the split leash. The first-end and the second-end each comprise a clip for fastening to the first-ring and second-ring. The wrap harness further comprises at least one pocket for storage. The split leash and the wrap harness provide a comfortable and effective means for walking or controlling a pet.

A kit is also disclosed herein including a set of instructions, a wrap harness, a split leash, and a storage container.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pet harness system, constructed and operative according to the teachings of the present disclosure.

FIG. 1 is a perspective view of the pet harness system during an ‘in-use’ condition, according to an embodiment of the disclosure.

FIG. 2 is a perspective view of the pet harness system of FIG. 1, according to an embodiment of the present disclosure.

FIG. 3 is a perspective view of the pet harness system of FIG. 1, according to an embodiment of the present disclosure.

FIG. 4 is a perspective view of the pet harness system of FIG. 1, according to an embodiment of the present disclosure.

FIG. 5 is a perspective view of the pet harness system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a pet accessory and more particularly to a pet harness system as used to improve the effective use of canine harnesses.

Generally, the pet harness system includes a harness. The harness is preferably constructed of a lightweight breathable and machine washable material on the bottom and the top is a stretchable material to help aid in a snug fit for all dogs. The harness preferably has two b-rings located over each of the dog's shoulders. A pocket may also be included on the back of harness. The pocket may be used for storage of items such as waste bags. The leash is designed such that it splits in two sections near the end in order to attach to each of the D rings. The leash also includes a loop which may be used to put a seat belt through and retain a dog. Another karabiner may be used to convert the leash to a to hands-free leash. A storage container may be provided. The storage container is a water proof snap lid plastic container to be used as a portable no spill water dish.

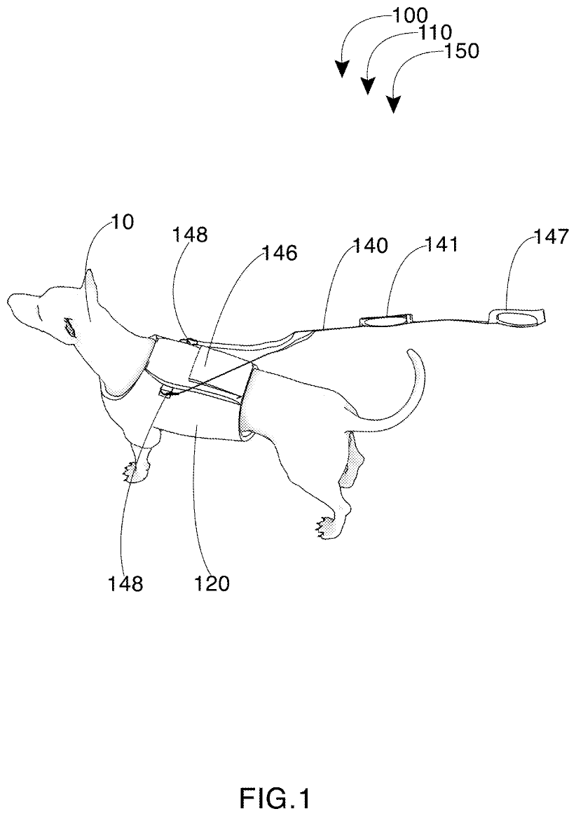

Referring now more specifically to the drawings by numerals of reference, there is shown in FIGS. 1-5, various views of a pet harness system 100. FIG. 1 shows a pet harness system 100 during an ‘in-use’ condition 150, according to an embodiment of the present disclosure. As illustrated, the pet harness system 100 may include a harness assembly 110 including a wrap harness 120 having a pair of leg apertures 124, a closure-section 128, a first-ring 132, and a second-ring 136, a split leash 140 having a first-end 142 and a second-end 144. The split leash 140 and the wrap harness 120 of the harness assembly 110 are configured to be used in combination for controlling a pet 10.

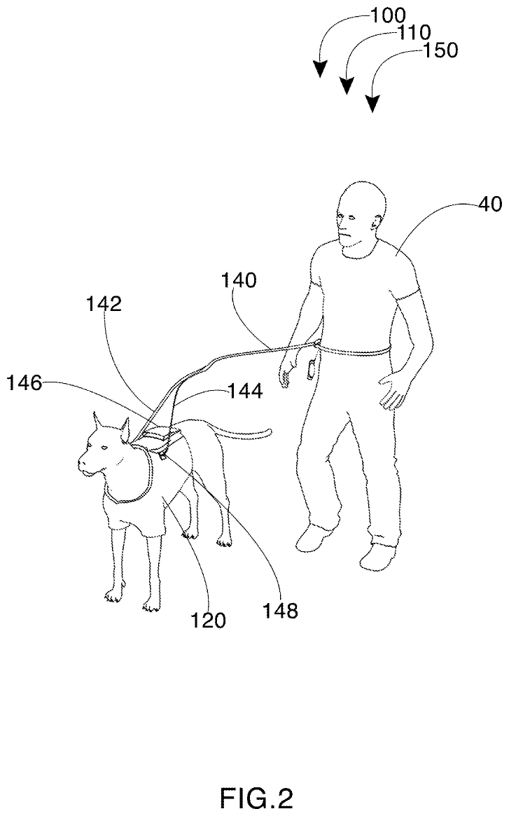

FIG. 2 shows a perspective view of the pet harness system 100 of FIG. 1, according to an embodiment of the present disclosure. As above, the pet harness system 100 may include the harness assembly 110 including the wrap harness 120 having the pair of leg apertures 124, the closure-section 128, the first-ring 132, and the second-ring 136, and the split leash 140 having the first-end 142 and the second-end 144. The wrap harness 120 is configured to be worn by a pet 10. The pair of leg apertures 124 are each configured to receive a leg of the pet 10. The closure-section 128 includes a fastener 130 which is configured to secure the wrap harness 120 around a pet-body. The first-ring 132 is configured to receive the first-end 142 of the split leash 140 and the second-ring 136 is configured to receive the second-end 144 of the split leash 140.

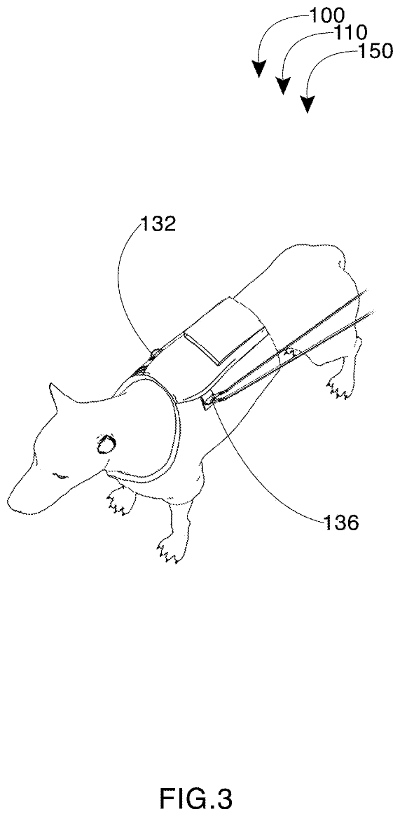

Referring now to FIG. 3 showing a perspective view of the pet harness system 100 of FIG. 1, according to an embodiment of the present disclosure. As above, the pet harness system 100 may include the wrap harness 120 and the split leash 140. In a preferred embodiment, the first-ring 132 and second-ring 136 of the wrap harness 120 comprise D-rings. The first-end 142 and the second-end 144 of the split leash 140 each comprise a clip 148 for fastening to the first-ring 132 and second-ring 136. The first-ring 132 and second-ring 136 are positioned proximal to each shoulder of the pet 10 during an in-use condition. The first-ring 132 and second-ring 136 oppose one another. The split leash 140 splits into the first-end 142 and the second-end 144 proximal to the clips 148. The first-end 142 and the second-end 144 comprise equal lengths.

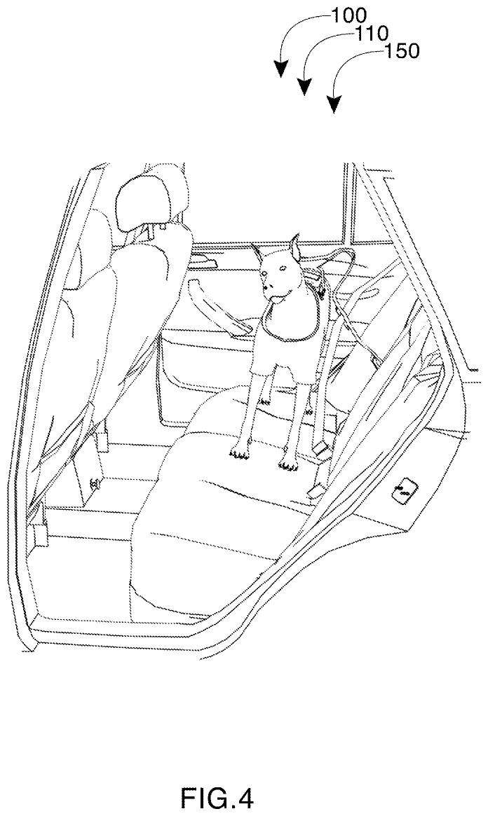

FIG. 4 shows a perspective view of the pet harness system 100 of FIG. 1, according to an embodiment of the present disclosure. As above, the pet harness system 100 may include the harness assembly 110. The split leash 140 and the wrap harness 120 are configured for even weight distribution and maximum comfort for a dog. The wrap harness 120 includes a simple structure without buckles hitting a dog's spine while walking. The split leash 140 further comprises a loop 141. The loop 141 of the split leash 140 is positioned in a middle section of a length of the split leash 140. A user may insert a seatbelt through the loop 141 to secure a pet 10 in a vehicle. The split leash comprises a handle 147 which may be held by a user for walking or restraining a pet. Further, the split leash 140 and the wrap harness 120 are configured to be used in a hands-free manner.

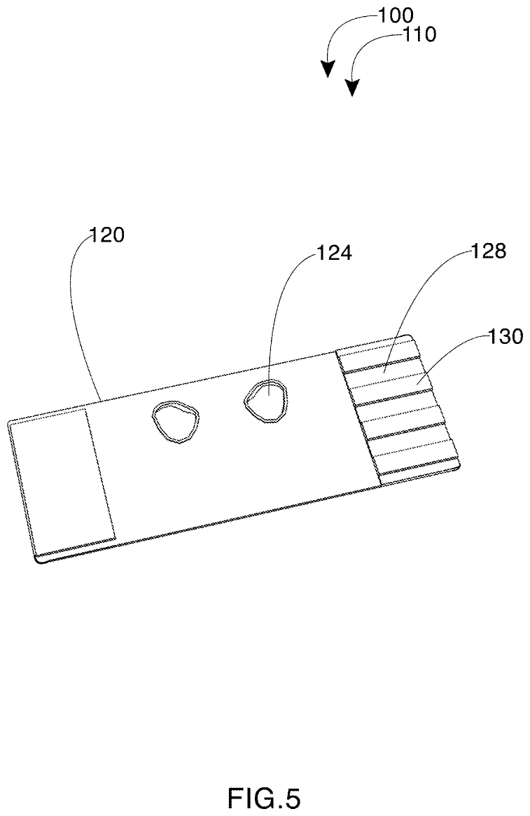

FIG. 5 shows a perspective view of the pet harness system 100 of FIG. 1, according to an embodiment of the present disclosure. As above, the pet harness system 100 may include the wrap harness 120 and split leash 140. The wrap harness 120 comprises a machine-washable fabric. The wrap harness 120 further comprises reflective members. The wrap harness 120 further comprises at least one pocket 146 for storage which may be used for storing waste pick-up items. In a preferred embodiment, the fastener 130 of the closure-section 128 is a hook and loop fastener having a male-fastener and a female-fastener.

According to one embodiment, the pet harness system 100 may be arranged as a kit. The kit may include a set of instructions; a wrap harness 120; a split leash 140; and a storage container. The instructions may detail functional relationships in relation to the structure of the pet harness system 100 (such that the pet harness system 100 can be used, maintained, or the like, in a preferred manner).

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet harness system comprising:
a harness assembly;
a wrap harness having;
a pair of leg apertures;
a closure-section;
a first-ring; and
a second-ring;
a split leash having;
a first-end; and
a second-end;
wherein said wrap harness is configured to be worn by a pet;
wherein said pair of leg apertures are each configured to receive a leg of said pet;
wherein said closure-section includes a fastener which is configured to secure said wrap harness around a pet-body;
wherein said first-ring is configured to receive said first-end of said split leash and said second-ring is configured to receive said second-end of said split leash; and
wherein said split leash and said wrap harness are configured to be used in combination for controlling an animal.

2. The pet harness system of claim 1, wherein said first-ring and second-ring comprise D-rings.

3. The pet harness system of claim 1, wherein said first-end and said second-end each comprise a clip for fastening to said first-ring and second-ring.

4. The pet harness system of claim 3, wherein said first-ring and second-ring are positioned proximal to each shoulder of said pet during an in-use condition.

5. The pet harness system of claim 4, wherein said first-ring and second-ring oppose one another.

6. The pet harness system of claim 3, wherein said split leash splits into said first-end and said second-end proximal to said clips.

7. The pet harness system of claim 1, wherein said first-end and said second-end comprise equal lengths.

8. The pet harness system of claim 1, wherein said split leash and said wrap harness are configured for even weight distribution.

9. The pet harness system of claim 1, wherein said split leash further comprises a loop.

10. The pet harness system of claim 9, wherein said loop of said split leash is positioned in a middle section of a length of said split leash.

11. The pet harness system of claim 1, wherein said split leash and said wrap harness are configured to be used in a hands-free manner.

12. The pet harness system of claim 1, wherein said split leash comprises a handle.

13. The pet harness system of claim 1, wherein said wrap harness comprises a machine-washable fabric.

14. The pet harness system of claim 1, wherein said fastener of said closure-section is a hook and loop fastener having a male-fastener and a female-fastener.

15. The pet harness system of claim 1, wherein said wrap harness further comprises reflective members.

16. The pet harness system of claim 1, wherein said harness assembly further includes a storage container.

17. The pet harness system of claim 16, wherein said storage container is a portable water dish having a removeable lid.

18. The pet harness system of claim 1, wherein said wrap harness further comprises at least one pocket for storage.

19. A pet harness system, the pet harness system comprising:
a harness assembly;
a wrap harness having;
a pair of leg apertures;
a closure-section;
a first-ring; and
a second-ring;
a split leash having;
a first-end; and
a second-end;
wherein said wrap harness is configured to be worn by a pet;
wherein said pair of leg apertures are each configured to receive a leg of said pet;
wherein said closure-section includes a fastener which is configured to secure said wrap harness around a pet-body;
wherein said fastener of said closure-section is a hook and loop fastener having a male-fastener and a female-fastener;
wherein said first-ring is configured to receive said first-end of said split leash and said second-ring is configured to receive said second-end of said split leash;
wherein said split leash and said wrap harness are configured to be used in combination for controlling an animal;
wherein said first-ring and second-ring comprise D-rings;
wherein said first-end and said second-end each comprise a clip for fastening to said first-ring and second-ring;
wherein said first-ring and second-ring are positioned proximal to each shoulder of said pet during an in-use condition;
wherein said first-ring and second-ring oppose one another;
wherein said split leash splits into said first-end and said second-end proximal to said clips;
wherein said first-end and said second-end comprise equal lengths;
wherein said split leash and said wrap harness are configured for even weight distribution;
wherein said split leash further comprises a loop;
wherein said loop of said split leash is positioned in a middle section of a length of said split leash;
wherein said split leash and said wrap harness are configured to be used in a hands-free manner;
wherein said split leash comprises a handle;
wherein said wrap harness comprises a machine-washable fabric;
wherein said wrap harness further comprises reflective members; and
wherein said wrap harness further comprises at least one pocket for storage.

20. The pet harness system of claim 19, further comprising a set of instructions; a wrap harness; a split leash; a storage container; and
wherein the pet harness system is arranged as a kit.
